(19) United States
(12) Patent Application Publication
(10) Pub. No.: US 2016/0084349 A1
(43) Pub. Date: Mar. 24, 2016

(54) HYBRID TRANSMISSION FOR VEHICLE

(71) Applicant: Hyundai Motor Company, Seoul (KR)

(72) Inventors: Baek Yu Kim, Suwon (KR); Sung Gon Byun, Anyang (KR); Seok Joon Kim, Yongin (KR); Chul Min Ahn, Busan (KR)

(73) Assignee: Hyundai Motor Company, Seoul (KR)

(21) Appl. No.: 14/558,992

(22) Filed: Dec. 3, 2014

(30) Foreign Application Priority Data
Sep. 23, 2014 (KR) 10-2014-0126524

(51) Int. Cl. F16H 3/085

(52) U.S. Cl. CPC F16H 3/085; Y10S 903/917; F16H 2003/0826

(57) ABSTRACT

A hybrid transmission for a vehicle is provided which prevents complete interception of motive power to a driving wheel during a gear shift process to improve the shift quality. In addition, the transmission implements various traveling modes with a simplified configuration to improve fuel efficiency of the vehicle through efficient traveling that meets traveling situations of the vehicle.

### CROSS-REFERENCE(S) TO RELATED APPLICATIONS

The present application claims priority of Korean Patent Application Number 10-2014-0126524 filed on Sep. 23, 2014, the entire contents of which application are incorporated herein for all purposes by this reference.

### BACKGROUND

1. Field of the Invention

The present invention relates to a hybrid transmission for a vehicle, and, more particularly, to a technology of a transmission structure, which improves shift quality through implementation of various traveling modes with a simplified configuration.

2. Description of Related Art

An AMT (Automated Manual Transmission) can achieve both convenience of automatic gear shift based on a traveling state of a vehicle without intervention of a driver like an automatic transmission in the related art and high power transfer efficiency of a manual transmission in the related art. However, during the gear shift, the AMT based on the manual transmission mechanism in the related art accompanies a process in which power that is transferred to drive wheels is intercepted while releasing a previous gear shift stage and shifting to a next gear shift stage, thus causing potential gear shift impacts to occur.

The terms described as a background technology of the present invention are merely to improve understanding of the background of the present invention, and should not be accepted to concede that the terms correspond to the related art already known to those of ordinary skill in the art.

### SUMMARY

An exemplary embodiment of the present invention is directed to a hybrid transmission for a vehicle, which may prevent complete interception of motive power to a driving wheel during a gear shift process to improve the shift quality, and may implement various traveling modes with a simplified configuration to improve fuel efficiency of the vehicle through efficient traveling that meets traveling situations of the vehicle. Other objects and advantages of the present invention can be understood by the following description, and become apparent with reference to the exemplary embodiments of the present invention. Also, it is obvious to those skilled in the art to which the present invention pertains that the objects and advantages of the present invention can be realized by the means as claimed and combinations thereof.

In accordance with an exemplary embodiment of the present invention, a hybrid transmission for a vehicle may include an engine clutch connected to an engine; an input shaft configured to receive engine power transferred through the engine clutch; a plurality of constrained drive gears installed on the input shaft to constrain rotations thereof; a free drive gear installed on the input shaft with free rotation and connected to a motor; a clutch configured to cause the free drive gear to be rotationally constrained by or unconstrained against the input shaft; a first output shaft and a second output shaft provided with a plurality of driven gears that are tooth-engaged with the plurality of constrained drive gears to form a plurality of gear shift stages; an EV1 (electric vehicle) driven gear tooth-engaged with the free drive gear and rotatably disposed on the first output shaft; an EV2 driven gear tooth-engaged with the free drive gear and rotatably disposed on the second output shaft; and a plurality of synchronizers configured to shift a state where the plurality of driven gears, the EV1 driven gear, and the EV2 driven gear of the first output shaft and the second output shaft are rotationally constrained by or unconstrained against the first output shaft or the second output shaft.

According to the present invention, the complete interception of the power to the driving wheel during the gear shift process may be prevented to improve the shift quality, and various traveling modes may be implemented with a simplified configuration to improve the fuel efficiency of the vehicle through the efficient traveling that meets the traveling situations of the vehicle.

### BRIEF DESCRIPTION OF THE DRAWINGS

The above and other features of the present invention will now be described in detail with reference to various exemplary embodiments thereof illustrated the accompanying drawings which are given hereinbelow by way of illustration only, and thus are not limitative of the present invention, and wherein:

FIG. 1 is an exemplary diagram illustrating the configuration of a hybrid transmission for a vehicle according to an exemplary embodiment of the present invention;

FIG. 2 is an exemplary diagram illustrating implementation of a 1-speed EV mode in the transmission of FIG. 1 according to an exemplary embodiment of the present invention;

FIG. 3 is an exemplary diagram illustrating implementation of a 2-speed EV mode in the transmission of FIG. 1 according to an exemplary embodiment of the present invention;

FIG. 4 is an exemplary diagram illustrating a state where an engine starts in the transmission of FIG. 1 according to an exemplary embodiment of the present invention;

FIG. 5 is an exemplary diagram illustrating implementation of a 1-speed HEV mode in the transmission of FIG. 1 according to an exemplary embodiment of the present invention;

FIG. 6 is an exemplary diagram illustrating implementation of a 2-speed HEV mode in the transmission of FIG. 1 according to an exemplary embodiment of the present invention;

FIG. 7 is an exemplary diagram illustrating implementation of another 2-speed HEV mode in the transmission of FIG. 1 according to an exemplary embodiment of the present invention;

FIG. 8 is an exemplary diagram illustrating implementation of a 3-speed HEV mode in the transmission of FIG. 1 according to an exemplary embodiment of the present invention;

FIG. 9 is an exemplary diagram illustrating implementation of another 3-speed HEV mode in the transmission of FIG. 1 according to an exemplary embodiment of the present invention;

FIG. 10 is an exemplary diagram illustrating implementation of a 4-speed HEV mode in the transmission of FIG. 1 according to an exemplary embodiment of the present invention;

FIG. 11 is an exemplary diagram illustrating implementation of a 5-speed HEV mode in the transmission of FIG. 1 according to an exemplary embodiment of the present invention;

FIG. 12 is an exemplary diagram illustrating implementation of another 5-speed HEV mode in the transmission of FIG. 1 according to an exemplary embodiment of the present invention;

FIG. 13 is an exemplary diagram illustrating implementation of a 6-speed HEV mode in the transmission of FIG. 1 according to an exemplary embodiment of the present invention; and

FIG. 14 is an exemplary diagram illustrating implementation of another 6-speed HEV mode in the transmission of FIG. 1 according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Exemplary embodiments of the present invention will be described below in more detail with reference to the accompanying drawings. The present invention may, however, be embodied in different forms and should not be construed as limited to the exemplary embodiments set forth herein. Rather, these exemplary embodiments are provided so that this disclosure will be thorough and complete, and will fully convey the scope of the present invention to those skilled in the art. Throughout the disclosure, like reference numerals refer to like parts throughout the various figures and embodiments of the present invention.

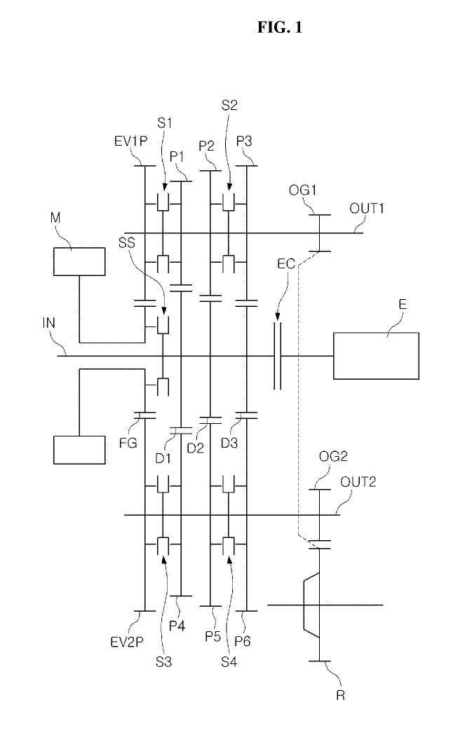

Referring to FIG. 1, a hybrid transmission for a vehicle in accordance with an exemplary embodiment of the present invention may include an engine clutch EC connected to an engine E; an input shaft IN configured to receive engine power transferred from the engine clutch EC; a plurality of constrained drive gears installed on the input shaft IN with constrained rotations (e.g., unable to rotate, fixed, etc.); a free drive gear FG installed on the input shaft IN with free rotation (e.g., unconstrained rotation) and connected to a motor M; a clutch configured to cause the free drive gear FG to be rotationally constrained by or unconstrained against the input shaft IN; a first output shaft OUT1 and a second output shaft OUT2 provided with a plurality of driven gears that are tooth-engaged with the plurality of constrained drive gears to form a plurality of gear shift stages; an EV1 driven gear EV1P tooth-engaged with the free drive gear FG and rotatably disposed on the first output shaft OUT1; an EV2 driven gear EV2P tooth-engaged with the free drive gear FG and rotatably disposed on the second output shaft OUT2; and a plurality of synchronizers configured to shift a state where the plurality of driven gears, the EV1 driven gear EV1P, and the EV2 driven gear EV2P of the first output shaft OUT1 and the second output shaft OUT2 are rotationally constrained by or unconstrained against the first output shaft OUT1 or the second output shaft OUT2.

In other words, according to the present invention, the power of the engine E may be transferred to the input shaft IN through the engine clutch EC, and the plurality of gear shift stages may be formed between the constrained drive gears on the input shaft IN and the driven gears on the first output shaft OUT1 and the second output shaft OUT2. When the motor M is connected to the free drive gear FG disposed on the input shaft IN, the power of the motor M may be drawn to the first output shaft OUT1 and the second output shaft OUT2 through the EV1 driven gear EV1P and the EV2 driven gear EV2P. When the gear shift stage between the constrained drive gears and the driven gears is changed, the power of the motor M may be continuously drawn to the drive wheels through the first output shaft OUT1 or the second output shaft OUT2 through the EV1 driven gear EV1P or the EV2 driven gear EV2P to prevent the power interception during the gear shift operation as seen in the related art.

A first output gear OG1 may be disposed on the first output shaft OUT1, and a second output gear OG2 may be disposed on the second output shaft OUT2. The first output gear OG1 and the second output gear OG2 may be engaged with a differential ring gear R to draw the power to the drive wheels. In this exemplary embodiment, the motor M may be installed on the concentric shaft of the input shaft IN, and the clutch may include a start synchro mechanism SS operating as a synchronizer having a hub that is disposed on the input shaft IN. In particular, the clutch may be a dog clutch. The driven gears of the first output shaft OUT1 may be tooth-engaged with the constrained drive gears of the input shaft IN, and may be arranged to form relatively lower gear shift stages among a series of gear shift stages. The driven gears of the second output shaft OUT2 may be tooth-engaged with the constrained drive gears of the input shaft IN, and may be arranged to form relatively higher gear shift stages among the series of gear shift stages.

In this exemplary embodiment, the constrained drive gears of the input shaft IN may include a first drive gear D1, a second drive gear D2, and a third drive gear D3, and a first stage driven gear P1 tooth-engaged with the first drive gear D1 to form a first gear shift stage, a second stage driven gear P2 tooth-engaged with the second drive gear D2 to form a second gear shift stage, and a third stage driven gear P3 tooth-engaged with the third drive gear D3 to form a third gear shift stage may be rotatably installed on the first output shaft OUT1. Further, a fourth stage driven gear P4 tooth-engaged with the first drive gear D1 to form a fourth gear shift stage, a fifth stage driven gear P5 tooth-engaged with the second drive gear D2 to form a fifth gear shift stage, and a sixth stage driven gear P6 tooth-engaged with the third drive gear D3 to form a sixth gear shift stage may be rotatably installed on the second output shaft OUT2.

The plurality of synchronizers may include a first synchronizer S1 installed on the first output shaft OUT1 to cause any one of the EV1 driven gear EV1P and the first stage driven gear P1 to be rotationally constrained by or unconstrained against the first output shaft OUT1, a second synchronizer S2 installed on the first output shaft OUT1 to cause any one of the second stage driven gear P2 and the third stage driven gear P3 to be rotationally constrained by or unconstrained against the first output shaft OUT1, a third synchronizer S3 installed on the second output shaft OUT2 to cause any one of the EV2 driven gear EV2P and the fourth stage driven gear P4 to be rotationally constrained by or unconstrained against the second output shaft OUT2, and a fourth synchronizer S4 installed on the second output shaft OUT2 to cause any one of the fifth stage driven gear P5 and the sixth stage driven gear P6 to be rotationally constrained by or unconstrained against the second output shaft OUT2.

Furthermore, the engine clutch EC may a normal close type clutch. Under the assumption that the vehicle traveling is performed in a HEV mode to be described later, the normal close type engine clutch EC may be maintained in a fastening state in the HEV (hybrid electric vehicle) mode, and thus unnecessary operation energy consumption may be prevented contributing to the improvement of fuel efficiency of the vehicle.

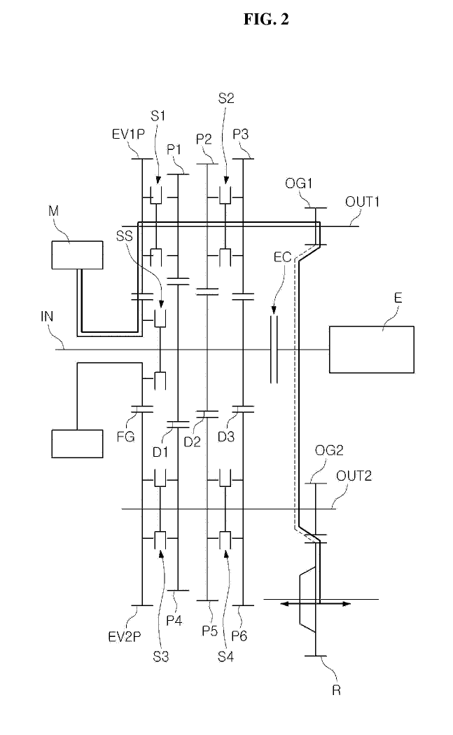

FIG. 2 illustrates a state where a 1-speed EV (electric vehicle) mode is implemented in the transmission according to this exemplary embodiment. When the first synchronizer S1 causes the EV1 driven gear EV1P to be rotationally constrained by the first output shaft OUT1, the power generated by the motor M may be transferred to the first output shaft OUT1 from the free drive gear FG and the EV1 driven gear EV1P to be drawn to the differential ring gear R.

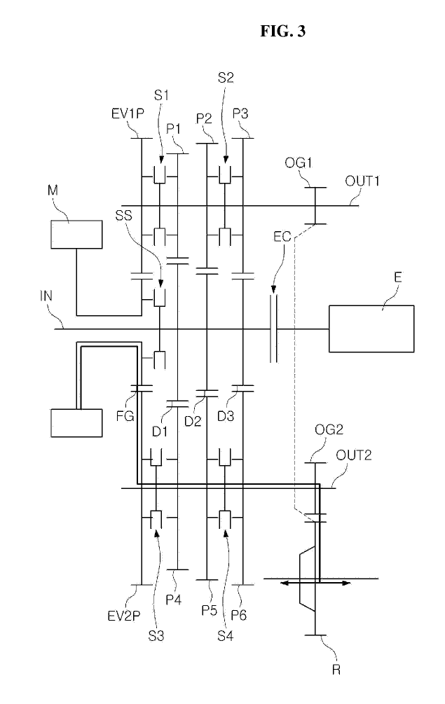

FIG. 3 illustrates a 2-speed EV mode. When the third synchronizer S3 causes the EV2 driven gear EV2P to be rotationally constrained by the second output shaft OUT2, the power generated by the motor M may be transferred to the second output shaft OUT2 from the free drive gear FG and the EV2 driven gear EV2P to be drawn to the ring gear R.

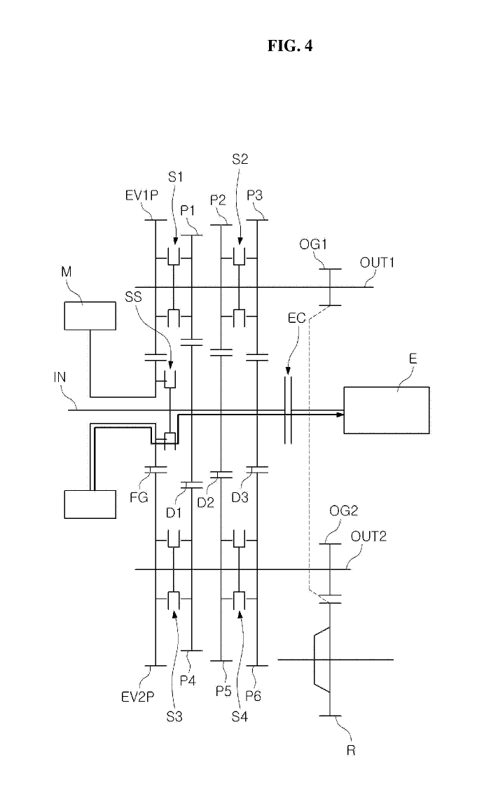

FIG. 4 illustrates a state where an engine E is starting. When the motor M is driven in a state where the free drive gear FG is connected to the input shaft IN by the start synchro mechanism SS, the power of the motor M may be transferred to the engine E from the input shaft IN, and a rotating force required to start the engine E may be supplied to start the engine E.

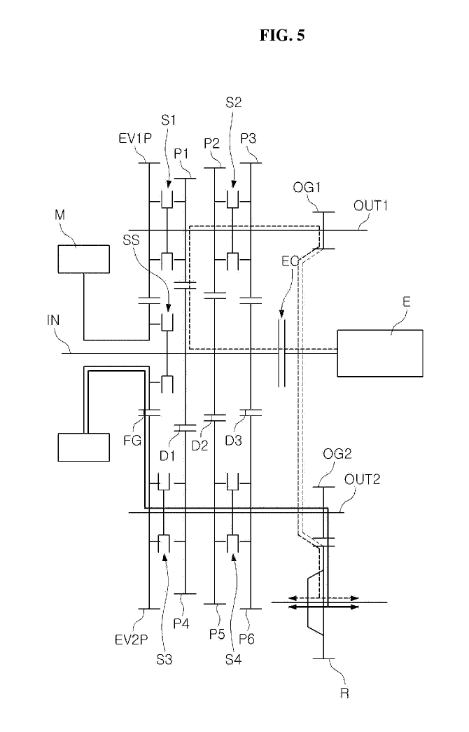

FIG. 5 illustrates a 1-speed HEV mode. The third synchronizer S3 may be configured to connect the EV2 driven gear EV2P to the second output shaft OUT2, and the power of the motor M may be transferred to the second output shaft OUT2. Simultaneously, the first synchronizer S1 may be combined with the engine clutch EC to transfer the power of the engine E in a state where the first stage driven gear P1 is connected to the first output shaft OUT1. Accordingly, the power of the engine E may be transferred to the differential ring gear R from the first output shaft OUT1 and the power of the motor M may be transferred to the ring gear R from the second output shaft OUT2, and the two powers join together on the ring gear R to be provided to the respective drive wheels.

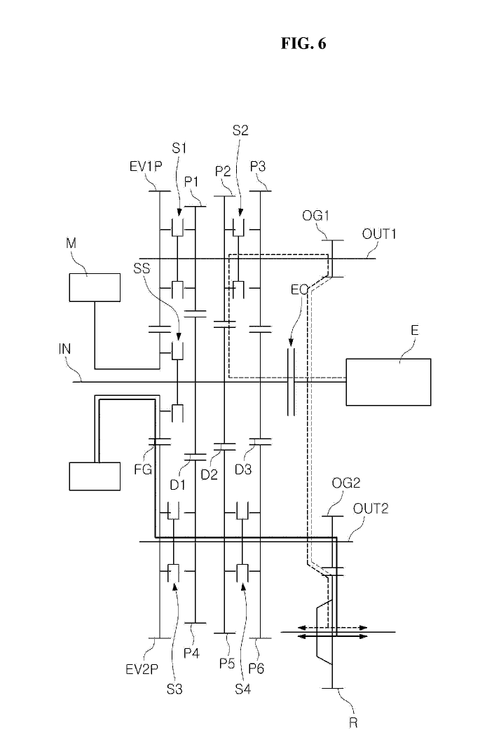

FIG. 6 illustrates a 2-speed HEV mode. From the state as illustrated in FIG. 5, the first synchronizer S1 may be configured to release the rotation constrained state of the first stage driven gear P1, and when the second stage driven gear P2 is rotationally constrained by the first output shaft OUT1, the second synchronizer S2 may be connected to the engine clutch EC. In particular, the power of the engine E may be transferred to the first output shaft OUT1 from the second drive gear D2, the second stage driven gear P2, and the second synchronizer S2, and the power of the engine E and the power of the motor M may join together on the differential ring gear R.

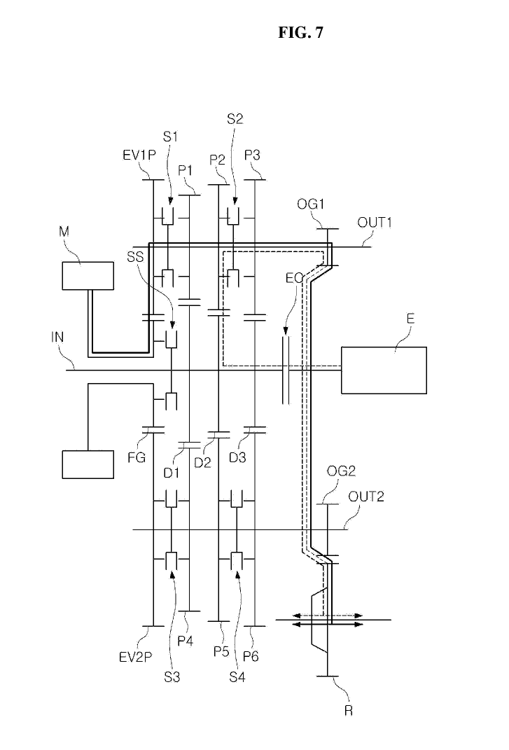

FIG. 7 illustrates another 2-speed HEV mode. When the combined state of the second stage driven gear P2 by the second synchronizer S2 is maintained, the first synchronizer S1, instead of the third synchronizer S3, may be configured to connect the EV1 driven gear EV1P to the first output shaft OUT1, and the power of the motor M may be transferred to the ring gear R from the first output shaft OUT1. As a result, the power of the motor M and the power of the engine E may join together on the first output shaft OUT1 to be drawn out.

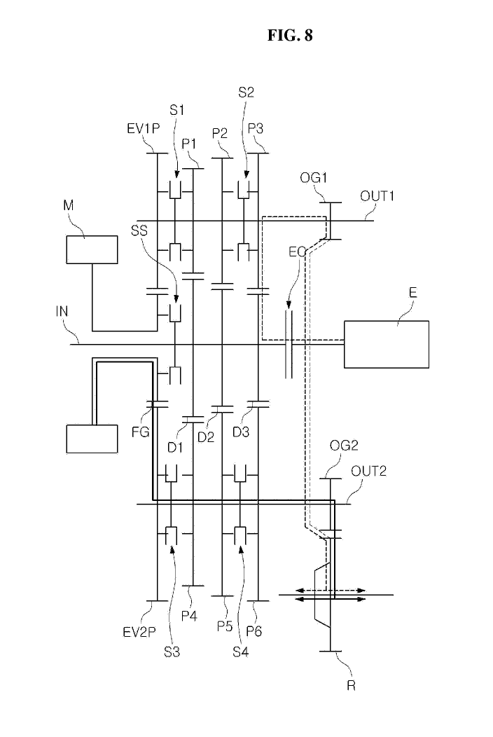

FIG. 8 illustrates a 3-speed HEV mode. The third synchronizer S3 may be configured to connect the EV2 driven gear EV2P to the second output shaft OUT2, and the second synchronizer S2 may be configured to connect the third stage driven gear P3 to the first output shaft OUT1. In particular, the power of the motor M may be transferred to the ring gear R from the second output shaft OUT2, and the power of the engine E may be transferred to the ring gear R from the first output shaft OUT1.

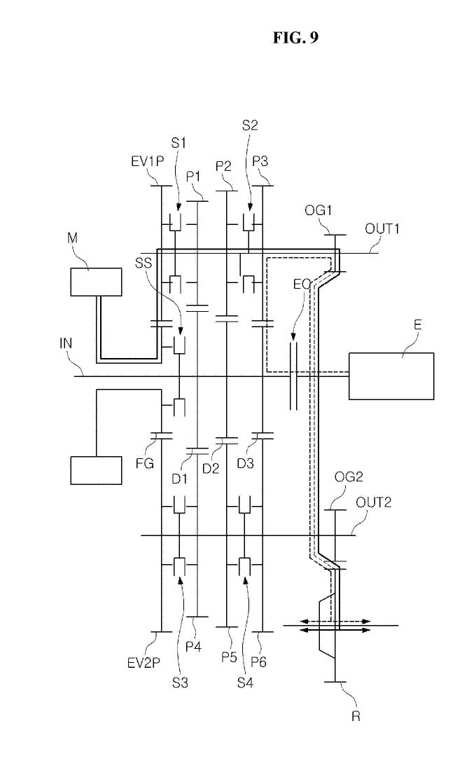

FIG. 9 illustrates another 3-speed HEV mode. When the first synchronizer S1 connects the EV1 driven gear EV1P to the first output shaft OUT1 and the second synchronizer S2 connects the third stage driven gear P3 to the first output shaft OUT1, both the power of the motor M and the power of the engine E may be transferred to the ring gear R from the first output shaft OUT1.

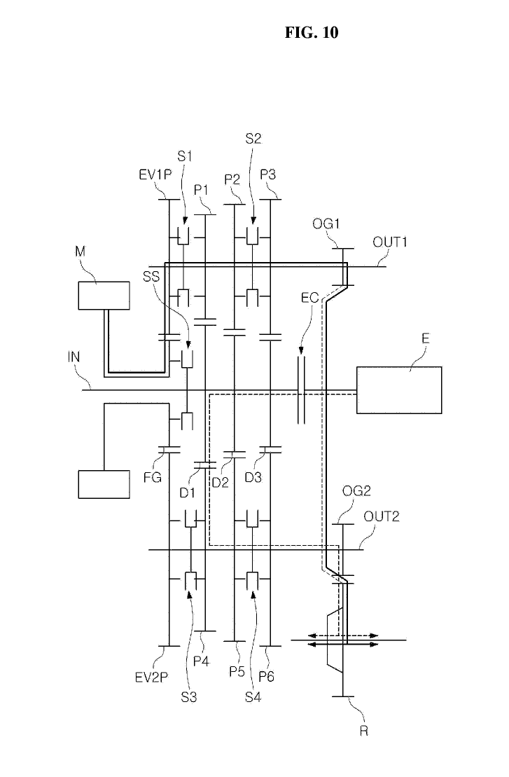

FIG. 10 illustrates a 4-speed HEV mode. The first synchronizer S1 may be configured to connect the EV1 driven gear EV1P to the first output shaft OUT1, and the power of the motor M may be transferred to the ring gear R from the first output shaft OUT1. In particular, the third synchronizer S3 may be configured to connect the fourth stage driven gear P4 to the second output shaft OUT2 to transfer the power of the engine E to the ring gear R from the fourth stage driven gear P4 and the second output shaft OUT2.

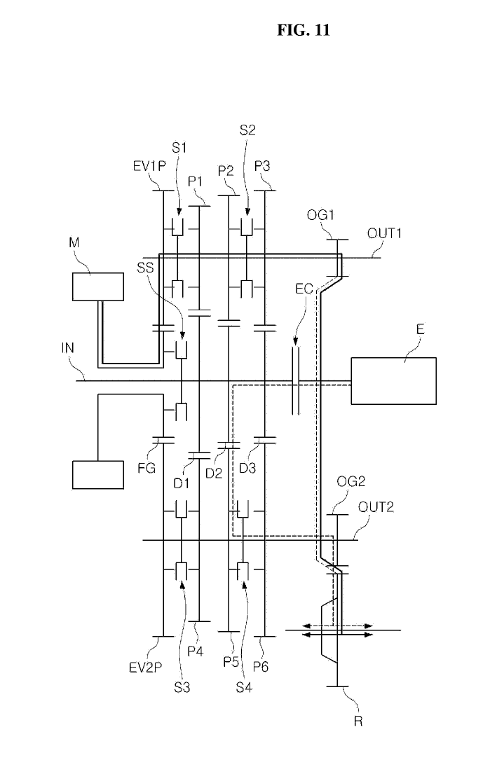

FIG. 11 illustrates a 5-speed HEV mode. When the first synchronizer S1 connects the EV1 driven gear EV1P to the first output shaft OUT1, the fourth synchronizer S4 may be configured to connect the fifth stage driven gear P5 to the second output shaft OUT2. In particular, the power of the engine E may be transferred to the ring gear R from the fifth stage driven gear P5 and the second output shaft OUT2, and the power of the motor M may be transferred to the ring gear R from the EV1 driven gear EV1P and the first output shaft OUT1.

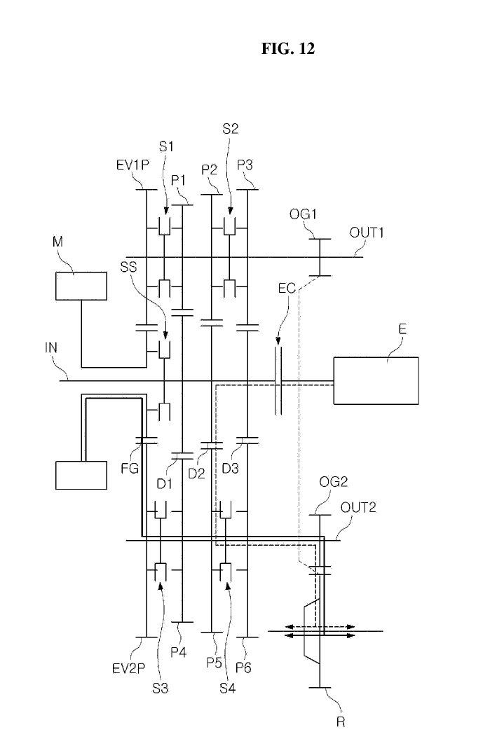

FIG. 12 illustrates another 5-speed HEV mode. Compared to the state of FIG. 11, the third synchronizer S3, instead of the first synchronizer S1, may be configured to connect the EV2 driven gear EV2P to the second output shaft OUT2. In particular, the power of the engine E from the fifth stage driven gear P5 and the power of the motor M from the EV2 driven gear EV2P may join together on the second output shaft OUT2 to be drawn to the ring gear R.

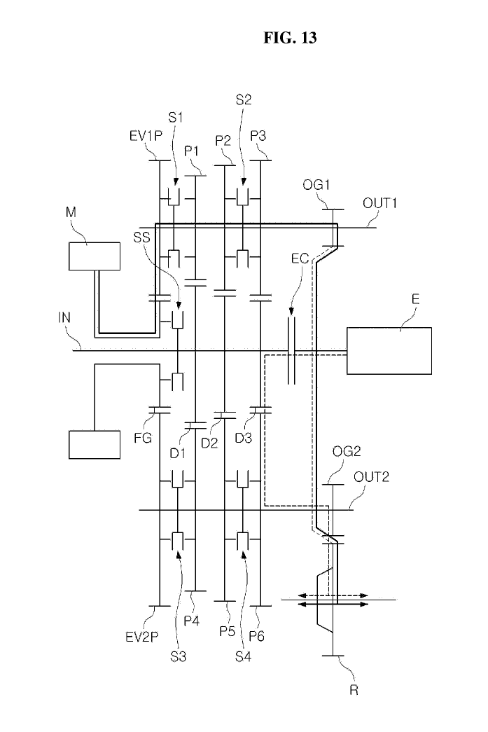

FIG. 13 illustrates a 6-speed HEV mode. When the first synchronizer S1 connects the EV1 driven gear EV1P to the first output shaft OUT1, the fourth synchronizer S4 may be configured to connect the sixth stage driven gear P6 to the second output shaft OUT2. In particular, the power of the motor M may be drawn to the differential ring gear R from the EV1 driven gear EV1P and the first output shaft OUT1, and the power of the engine E may be drawn to the differential ring gear R from the engine clutch EC, the sixth stage driven gear P6, and the second output shaft OUT2.

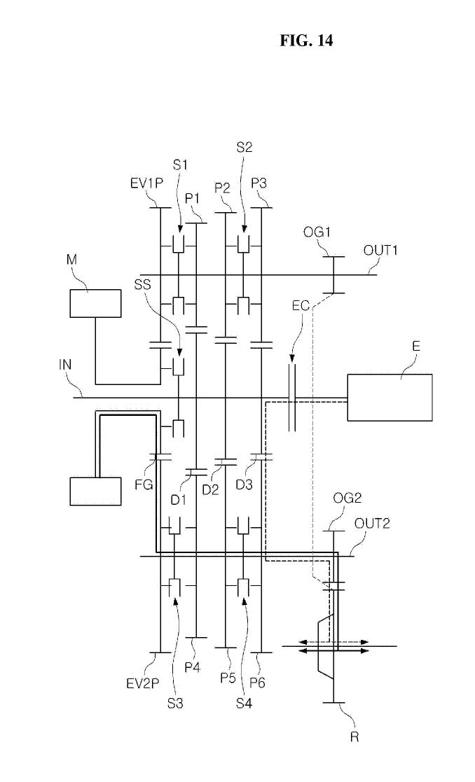

FIG. 14 illustrates another 6-speed HEV mode. The fourth synchronizer S4 and the sixth stage driven gear P6 may be in the same states as described above in relation to FIG. 13, and the third synchronizer S3, instead of the first synchronizer S1, may be configured to connect the EV2 driven gear EV2P to the second output shaft OUT2. In particular, both the power of the motor M and the power of the engine E may join on the second output shaft OUT2 to be drawn to the ring gear R.

Moreover, the gear shift operation of the transmission in accordance with the exemplary embodiment of the present invention from the 2-speed HEV mode of FIG. 6 to the 3-speed HEV mode of FIG. 8 will be described as an example. In the 2-speed HEV mode of FIG. 6, the engine clutch EC may be released, and the second stage driven gear P2 may be released by the second synchronizer S2. When the engine clutch EC is combined in a state where the third stage driven gear P3 is connected to the first output shaft OUT1, the 3-speed HEV mode of FIG. 8 may be implemented.

In such a gear shift operation, since the power of the motor M may be continuously drawn to the ring gear R from the EV2 driven gear EV2P and the second output shaft OUT2, the power interception phenomenon during the gear shift operation in the related art may be prevented, and thus the shift quality and the traveling of the vehicle may be improved. In the same principle as described above, the gear shift between other gear shaft stages may be performed to provide the power of the motor M to the drive wheels from the EV1 driven gear EV1P and the EV2 driven gear EV2P, the current gear shift stage may be released when the engine clutch EC is released, a new driven gear may be connected to shift to a target gear shift stage, and then the engine clutch EC may be combined to complete the gear shift without causing the power interception phenomenon to occur.

In accordance with the exemplary embodiments of the present invention, in the HEV traveling, it may be possible to assist motor torques of two different gear shift ratios through the EV1 driven gear and the EV2 driven gear, and thus not only torque assistance in low stage but also torque assistance in high stage may be implemented without heterogeneity.

While the present invention has been described with respect to the exemplary embodiments, it will be apparent to those skilled in the art that various changes and modifications may be made without departing from the spirit and scope of the invention as defined in the following claims.

What is claimed is:

1. A hybrid transmission for a vehicle, comprising:
an engine clutch connected to an engine;
an input shaft configured to receive engine power transferred from the engine clutch;
a plurality of constrained drive gears fixed on the input shaft;
a free drive gear rotatably installed on the input shaft and connected to a motor;
a clutch configured to cause the free drive gear to be rotationally constrained by or unconstrained against the input shaft;
a first output shaft and a second output shaft provided with a plurality of driven gears tooth-engaged with the plurality of constrained drive gears to form a plurality of gear shift stages;
an EV1 driven gear tooth-engaged with the free drive gear and rotatably disposed on the first output shaft;
an EV2 driven gear tooth-engaged with the free drive gear and rotatably disposed on the second output shaft; and
a plurality of synchronizers configured to shift a state where the plurality of driven gears, the EV1 driven gear , and the EV2 driven gear of the first output shaft and the second output shaft are rotationally constrained by or unconstrained against the first output shaft or the second output shaft.

2. The hybrid transmission of claim 1, wherein the motor is installed on a concentric shaft of the input shaft.

3. The hybrid transmission of claim 1, wherein the clutch includes a start synchro mechanism that is a synchronizer having a hub disposed on the input shaft.

4. The hybrid transmission of claim 1, wherein the driven gears of the first output shaft are tooth-engaged with the constrained drive gears of the input shaft, and are arranged to form relatively lower gear shift stages among a series of gear shift stages, and
the driven gears of the second output shaft are tooth-engaged with the constrained drive gears of the input shaft, and are arranged to form relatively higher gear shift stages among the series of gear shift stages.

5. The hybrid transmission of claim 4, wherein the constrained drive gears of the input shaft include a first drive gear, a second drive gear, and a third drive gear;
a first stage driven gear tooth-engaged with the first drive gear to form a first gear shift stage, a second stage driven gear tooth-engaged with the second drive gear to form a second gear shift stage, and a third stage driven gear tooth-engaged with the third drive gear to form a third gear shift stage are rotatably installed on the first output shaft; and
a fourth stage driven gear tooth-engaged with the first drive gear to form a fourth gear shift stage, a fifth stage driven gear tooth-engaged with the second drive gear to form a fifth gear shift stage, and a sixth stage driven gear tooth-engaged with the third drive gear to form a sixth gear shift stage are rotatably installed on the second output shaft.

6. The hybrid transmission of claim 5, wherein the plurality of synchronizers include:
a first synchronizer installed on the first output shaft to cause any one of the EV1 driven gear and the first stage driven gear to be rotationally constrained by or unconstrained against the first output shaft, and a second synchronizer installed on the first output shaft to cause any one of the second stage driven gear and the third stage driven gear to be rotationally constrained by or unconstrained against the first output shaft; and
a third synchronizer installed on the second output shaft to cause any one of the EV2 driven gear and the fourth stage driven gear to be rotationally constrained by or unconstrained against the second output shaft, and a fourth synchronizer installed on the second output shaft to cause any one of the fifth stage driven gear and the sixth stage driven gear to be rotationally constrained by or unconstrained against the second output shaft.

7. The hybrid transmission of claim 1, wherein the engine clutch includes a normal close type clutch.
